(19) United States
(12) Patent Application Publication
(10) Pub. No.: US 2021/0371188 A1
(43) Pub. Date: Dec. 2, 2021

(54) ROLLED PRODUCT WITH INTERWOVEN UNITS OF PRODUCT

(71) Applicant: Joseph Wood, Macon, GA (US)

(72) Inventor: Joseph Wood, Macon, GA (US)

(21) Appl. No.: 16/885,549

(22) Filed: May 28, 2020

(51) Int. Cl. B65D 83/08; B65D 33/00; B65F 1/00; B65B 63/04; A41D 19/00

(52) U.S. Cl. CPC B65D 83/0894; B65D 33/002; A41D 2400/70; B65B 63/04; A41D 19/0055; B65F 1/0006

(57) ABSTRACT

Illustrated views of items to be packaged for use are presented. The items are useful for preparing trash to be placed in a trash bin, protecting hands from harmful or infectious conditions, storage, etc. The items may be trash bags, gloves, and the like. The storage of bags and the like items is useful for any items which is stored rolled groupings and removed on a single item basis. The preparation of the items for retrieval of use provide a more efficient retrieval of the item and thus less down time and/or frustration during the process of getting a new item to use. The preparation of items provides for an efficient pull off the roll thus preventing a person from having to fiddle with each item.

### FIELD OF THE INVENTION

This invention relates to trash bags. More particularly, it relates to packaging of trash bags for consumers.

### BACKGROUND

A bin bag, rubbish bag, garbage bag, trash bag or refuse sack is a disposable bag used to contain solid waste. Such bags are useful to line the insides of waste containers to prevent the insides of the receptacle from becoming coated in waste material. Most bags these days are made out of plastic and are typically black in color.

Plastic bags are a convenient and sanitary way of handling garbage and are widely used. Plastic garbage bags are fairly lightweight and are particularly useful for messy or wet rubbish, as is commonly the case with food waste, and are also useful for wrapping up garbage to minimize odor. Plastic bags are often used for lining litter or waste containers or bins. This serves to keep the container sanitary by avoiding container contact with the garbage. After the bag in the container is filled with litter, the bag can be pulled out by its edges, closed, and tied with minimal contact with the waste matter.

One of the many chores that plague our everyday lives is taking out the trash from waste baskets and other sources commonly found in the American household. Although not time consuming and simple in routine, the job is often burdened by simple problems. Often times, the biggest obstacle to overcome is trying to retrieve the next bag from the roll when trying to find the end, or from a stack of folded bags in a box without removing five (5) at a time. The problems then continue when trying to open the bag as the edges seemingly seal themselves together. These same problems are present with other similar products such as boxes of disposable gloves.

According, in light of the foregoing, there is a need for a method by which trash can liners, disposable gloves or other similar products can easily be removed from their storage box in an open and ready to use state.

### BRIEF DESCRIPTION OF THE DRAWINGS

FIGS. 1A-1D are illustrated views of items to be packed for use.

FIGS. 2A-2D are illustrated views of an exemplary insertion of items as shown in FIGS. 1A-1D into each other for preparing items.

FIGS. 3A-3C are illustrated views of folds for rolling the items shown in

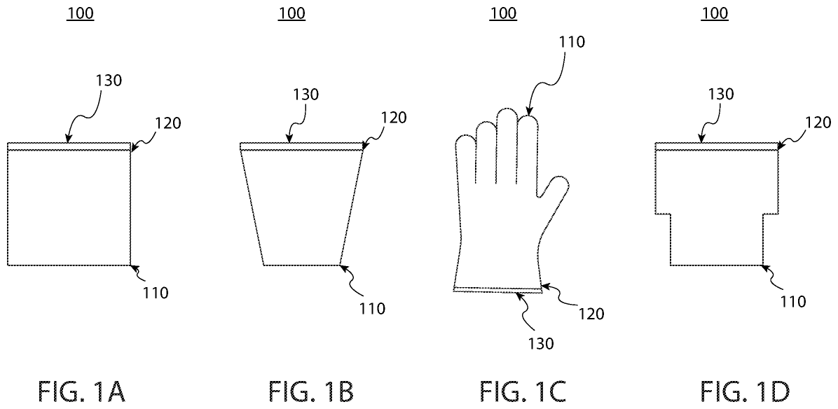

FIGS. 1A-1D.

FIGS. 4A-4B are illustrated views of half folded items shown in FIG. 1A.

FIGS. 4C-4D are illustrated view of zig-zag folds of the items shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Referring to FIGS. 1A-1D, illustrated views of items 100 to be packaged for use are presented. The items 100 are useful for preparing trash to be placed in a trash bin, protecting hands from harmful or infectious conditions, storage, etc. The items 100 may be trash bags, gloves, and the like. The storage of bags and the like items 100 is useful for any items which are stored rolled groupings and removed on a single item basis. The preparation of the items for retrieval of use provide a more efficient retrieval of the item 100 and thus less down time and/or frustration during the process of getting a new item 100 to use. The preparation of items 100 provide for an efficient pull off the roll thus preventing a person from having to fiddle with each item 100.

FIG. 1A presents a standard rectangular bag, FIG. 1B presents a trapezoidal bag, FIG. 1C presents a glove for a person's hand and FIG. 1D presents bags with clipped bottoms.

Each of the items 100 in FIGS. 1A-1D have a closed end 110 and an open end 120. The open end 120 of the item allows for an inside 130 of the item 100 to receive trash, a hand, etc. The closed end 110 prevents the trash, hand, etc. from sliding through the item 100 and being outside of the item 100.

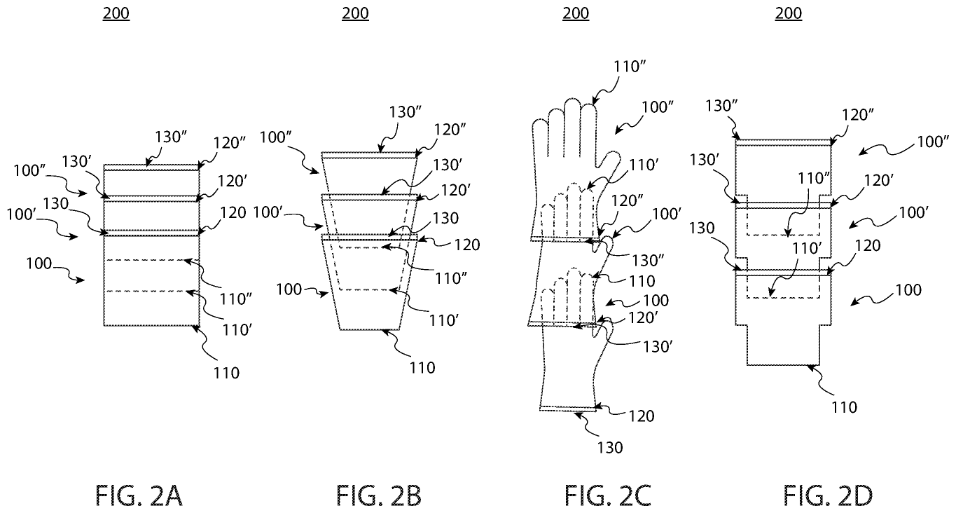

Moving now to FIGS. 2A-2D, an illustrated view of each of the items 100 shown in FIGS. 1A-1D being rolled, stacked or placed inside of a similar item 100. For example, the closed end 110 of the item 100 is inserted into the open end 120′ of a second of the item 100′.

The first stage of the method or process is to create a stack 200 by placing the closed end 110 of a first item 100 into the open end 120′ of a second item 100′. The closed end 110′ of the second item 100′ is inserted, at least partially, into the open end 120″ of a third item 100″. This process continues until all items 100 have been configured as part of the stack 200.

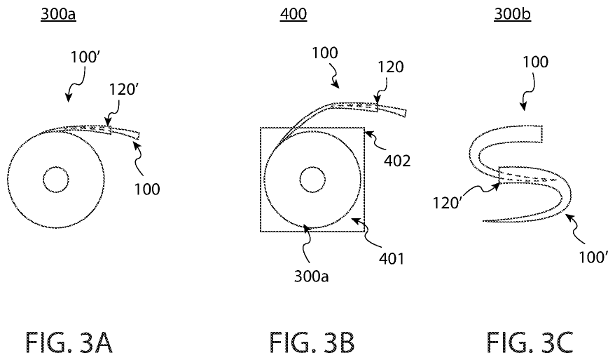

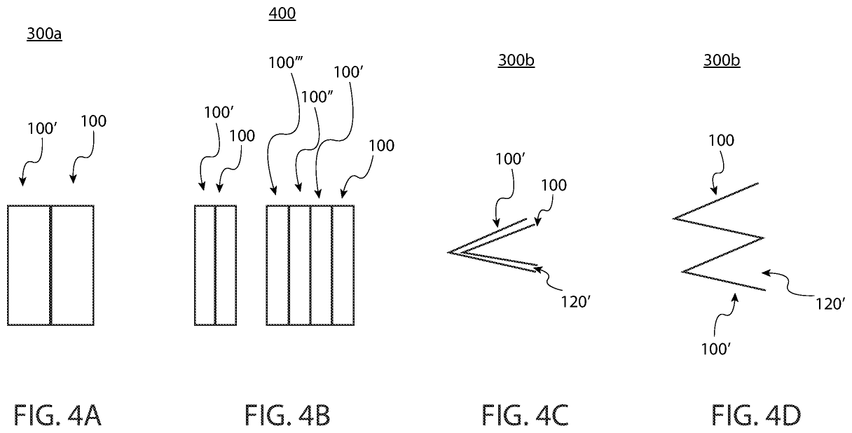

Moving now to FIGS. 3A-3C, are illustrated views of rolling the items 100 shown in FIGS. 1A-1D is presented. The next step of the process is to roll the stack 200 shown in FIGS. 2A-2D.

FIG. 3A presents a first type of roll 300a. The items 100 of the roll 300a being folded in rolled pattern. Thus, the roll 300a is configured to be in a singular line. The closed end 110 of the roll 300a is the beginning of creating the roll 300a of the items 100. As a person pulls a first of the items 100, the second of the items 100′ is pulled and the open end 120′ of the second of the items 100′ is open such that when it is pulled the person does not have to fumble around the item 100′ to try to open the item 100′ and becoming frustrated and potentially giving up.

FIG. 3B presents a zoom out of the roll 300a of items 100 using a container 400 for use. The container 400 has the roll 300a of the items 100. The roll 300a of the items 100 are on an inside 401 of the container 400 with the open end 120 of the first of the items 100 being extended out of a top 402 of the container 400.

FIG. 3C presents an illustrated view of a zoom in of the zig-zag roll 300b of the items 100. The roll 300b of items 100 being folded in a zig-zag pattern for dispensing each of the items 100. The closed end 110 of the first of the items 100 is shown inserted into the open end 120′ of the second of the items 100′. As stated previously, the items 100 are continued until the last of the items 100 is folded into the roll 300b of items 100.

Referring now to FIG. 4A and FIG. 4B, a view of the roll 300a of the items is presented. The roll 300a is preferably half-folds. The half-folds are configured by folding the item 100 such as a bag or glove by bending the item 100 so that one part covers another part, often pressing the edge so that it stays in place.

Now in FIG. 4C and FIG. 4D, a view of the zig-zag roll 300b shown in FIG. 3C is presented. The roll 300b of items 100 are folded in a zig-zag pattern. This zig-zag pattern is more efficient when pulling of the first item 100 from the roll 300b of the items 100, the second item 100′ is released slightly from the roll 300b of items 100 and the open end 120′ of the item 100 is at least partially open to allow the person to easily open and use the next of the items 100′ in the roll 300b.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rolled product for easing retrieval of the next product, the product comprising:
a plurality of items, each of the items having a top, a bottom and an interior, wherein the bottom of a first of the plurality of items being configured to be in the interior of the top of a second of the plurality of items;
a fold, the fold being configured to bend the item to a pre-determined shape, and wherein the product being to be a roll; and
a container, the container being configured to receive the roll.

2. The product of claim 1, wherein the fold being a zig-zag fold.

3. The product of claim 1, wherein the fold being half-fold.

4. The product of claim 1, wherein the interior of the plurality of items being open.

5. The product of claim 1, wherein the items being a bag.

6. The product of claim 1, wherein the items being a glove.

7. The product of claim 1, wherein the items being a trapezoidal shape.

8. The product of claim 1, wherein the items being a glove shape.

9. The product of claim 1, wherein the items being a clipped bottom shape.

10. A method for creating a rolled product, the method comprising:
producing a plurality of items, each of the items having a top, a bottom and an interior;
opening the top of a first of the plurality of items;
inserting the bottom of a second of the plurality of items into the opening of a first of the plurality of items, wherein the bottom of the second of the items configured to be in the interior of the first item;
folding the plurality of items;
rolling the plurality of items; and
inserting the rolled plurality of items in a container.

11. The method of claim 10, wherein the folding being a zig-zag fold.

12. The method of claim 10, wherein the folding being half-fold.

13. The method of claim 10, wherein the interior of the plurality of items being open.

14. The method of claim 10, wherein the items being a bag.

15. The method of claim 10, wherein the items being a glove.

16. The method of claim 10, wherein the items being a trapezoidal shape.

17. The method of claim 10, wherein the items being a glove shape.

18. The method of claim 10, wherein the items being a clipped bottom shape.
